(19) United States
(12) Patent Application Publication
(10) Pub. No.: US 2018/0013336 A1
(43) Pub. Date: Jan. 11, 2018

(54) STATORS AND COILS FOR AXIAL-FLUX DYNAMOELECTRIC MACHINES

(71) Applicant: Emerson Electric Co., St. Louis, MO (US)

(72) Inventor: Xin LI, Maryland Heights, MO (US)

(21) Appl. No.: 15/205,907

(22) Filed: Jul. 8, 2016

(51) Int. Cl. H02K 16/02; H02K 1/27; H02K 1/16; F04C 29/00; F04C 28/08; H02K 3/18; F04C 18/02

(52) U.S. Cl. CPC H02K 16/02; H02K 3/18; H02K 1/2793; H02K 1/27; F04C 18/0215; F04C 29/0085; F04C 28/08; H02K 1/16

(57) ABSTRACT

A stator assembly includes a stator core defined by an inner periphery and an outer periphery, and a plurality of coils. The stator core includes a stator yoke. Each coil of the plurality of coils includes a first set of segments and a second set of segments each extending between the inner periphery and the outer periphery of the stator core. The first set of segments is arranged to form a first coil portion having a “V” shape and the second set of segments is arranged to form a second coil portion having a “V” shape. The first coil portion and the second coil portion each have a vertex and two ends. The ends of the first coil portion are coupled to the ends of the second coil portion. Other example stators, and example dynamoelectric machines and compressors including one or more stators are also disclosed.

### FIELD

The present disclosure relates to stators and coils for axial-flux dynamoelectric machines.

### BACKGROUND

This section provides background information related to the present disclosure which is not necessarily prior art.

Dynamoelectric machines such as electric motors and generators convert electric energy into mechanical energy, or vice versa. These motors can include radial designed motors where magnetic flux flows radially between a stator and a rotor, and axial designed motors where magnetic flux flows axially between a stator and a rotor. In some cases, axial designed motors can include more than one stator and/or more than one rotor.

### SUMMARY

This section provides a general summary of the disclosure, and is not a comprehensive disclosure of its full scope or all of its features.

According to one aspect of the present disclosure, an axial-flux dynamoelectric machine includes at least one rotor and at least one stator adjacent the at least one rotor in an axial direction. The at least one stator is defined by an inner periphery and an outer periphery. The at least one stator includes a stator yoke, a plurality of teeth extending from the stator yoke, and a plurality of coils. At least one of the plurality of coils is configured to form a winding. The plurality of teeth are spaced apart from one another to define a plurality of slots for receiving the plurality of coils. Each coil of the plurality of coils includes a first set of segments and a second set of segments each extending between the inner periphery and the outer periphery of the stator. The first set of segments is arranged to form a first coil portion having a “V” shape relative to a cross-section of the stator and the second set of segments is arranged to form a second coil portion having a “V” shape relative to a cross-section of the stator. The first coil portion and the second coil portion each have a vertex and two ends. The ends of the first coil portion are coupled to the ends of the second coil portion.

According to another aspect of the present disclosure, a stator assembly for an axial-flux dynamoelectric machine includes a stator core and a plurality of coils. The stator core is defined by an inner periphery and an outer periphery. The stator core includes a stator yoke and a plurality of teeth extending from the stator yoke. The plurality of teeth are spaced apart from one another to define a plurality of slots. The plurality of coils are positioned in the plurality of slots. At least one of the coils is configured to form a winding. Each coil of the plurality of coils includes a first set of segments and a second set of segments each extending between the inner periphery and the outer periphery of the stator core. The first set of segments is arranged to form a first coil portion having a “V” shape relative to a cross-section of the stator assembly and the second set of segments is arranged to form a second coil portion having a “V” shape relative to a cross-section of the stator assembly. The first coil portion and the second coil portion each have a vertex and two ends. The ends of the first coil portion are coupled to the ends of the second coil portion.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side view of a portion of a stator including coils for an axial-flux dynamoelectric machine according to one example embodiment of the present disclosure.

FIG. 2 is a top view of the stator of FIG. 1.

FIG. 3A is an isometric view of one coil of the stator shown in FIG. 1 in a planar configuration.

FIG. 3B is an isometric view of one coil of the stator shown in FIG. 3A in which the coil is folded into the coil shown in FIG. 1.

FIG. 4 is an isometric view of the stator of FIG. 1, with current flowing in one coil.

FIG. 5 is a side view of the stator of FIG. 1, with current flowing in one coil and magnetic flux induced by this current.

FIG. 6 is an isometric view of a portion of an axial-flux dynamoelectric motor including the stator of FIG. 1 and two rotors according to another example embodiment.

FIG. 7 is an isometric view of a stator for an axial-flux dynamoelectric machine and including a rectangular cross sectional shape according to yet another example embodiment.

FIG. 8 is an isometric view of a coil employable in the stator of FIG. 7 according to another example embodiment.

FIG. 9 is an isometric view of a portion of an axial-flux dynamoelectric motor including the stator of FIG. 7 and two rotors according to yet another example embodiment.

FIG. 10 is a cross-sectional side view of a compressor including the axial-flux dynamoelectric motor of FIG. 6 according to another example embodiment.

Corresponding reference numerals indicate corresponding parts, features, etc. throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

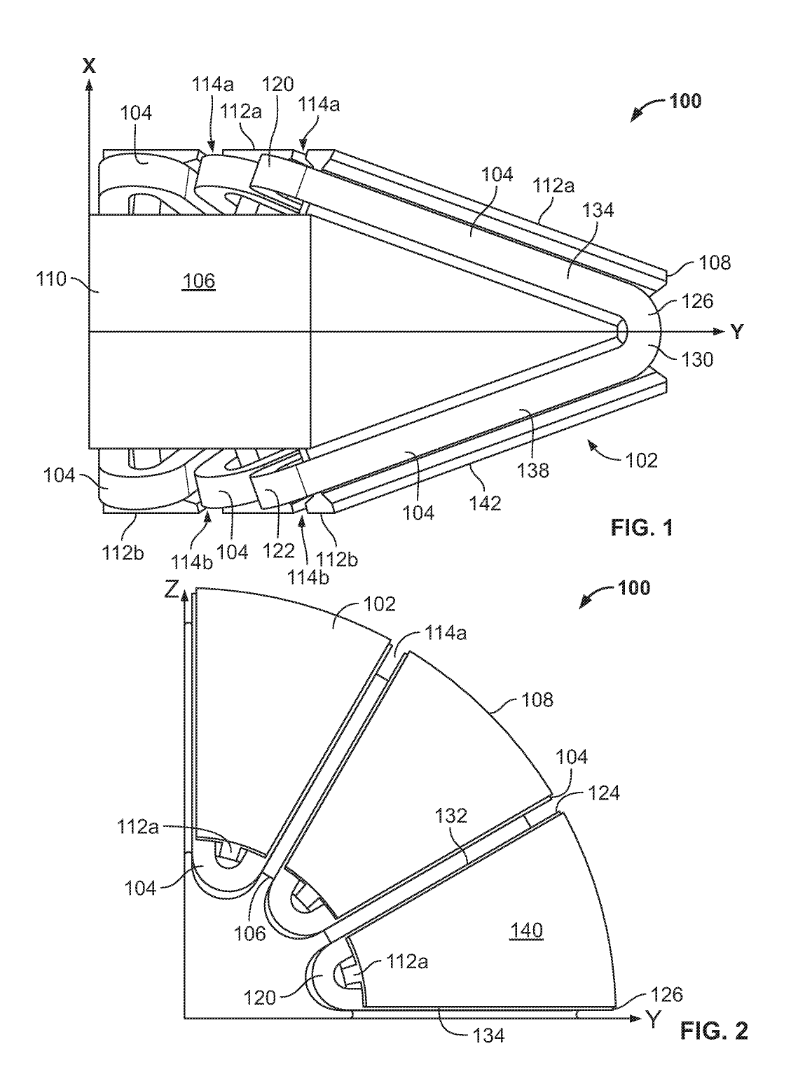

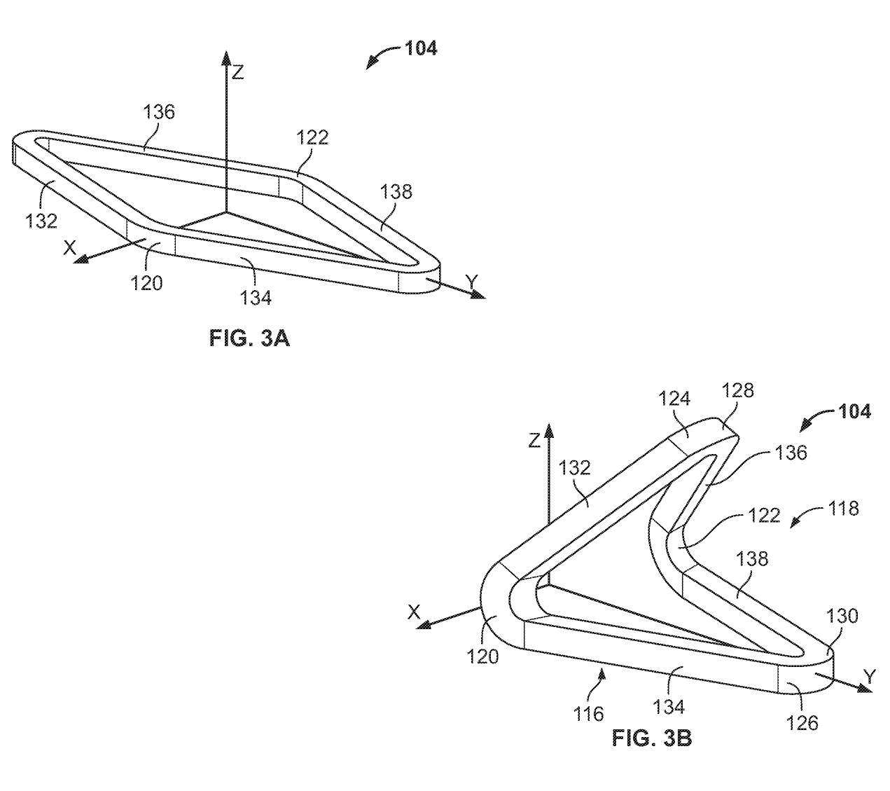

A portion of a stator for an axial-flux machine according to one example embodiment of the present disclosure is illustrated in FIGS. 1 and 2 and indicated generally by reference number 100. As shown in FIGS. 1 and 2, the stator 100 includes a stator core 102 and coils 104. The stator core 102 is defined by an inner periphery 106 and an outer periphery 108. The stator core 100 includes a stator yoke 110 and teeth 112 extending from the stator yoke 110. The teeth 112 are spaced apart from one another to define slots 114 for receiving the coils 104. At least one of the coils 104 forms a winding. Each coil 104 includes two sets of segments each extending between the inner periphery 106 and the outer periphery 108 of the stator core 102. As shown in FIG. 3, each set of segments is arranged to form a coil portion 116, 118 having a “V” shape relative to a cross-section of the stator 100 (relative to a top view of the stator 100). As shown best in FIG. 3, the coil portion 116 has a vertex 120 and two ends 124,126, and the coil portion 118 has a vertex 122 and two ends 128, 130. The ends 124,126 of the coil portion 116 are coupled to the ends 128, 130 of the coil portion 118.

As shown in FIGS. 1 and 3, the vertexes 120, 122 and the ends 124,126, 128, 130 of each coil 104 form end turns adjacent the inner periphery 106 and the outer periphery 108 of the stator 100, as further explained below. In particular, each coil 104 includes four end turns, two formed by the vertexes 120, 122 and two formed by the ends 124,126, 128, 130. These coil end turns as well as other end turns disclosed herein may be smaller (e.g., a shorter length, etc.) than coil end turns of conventional stators. The smaller coil end turns may reduce the amount of coil material such as copper, aluminum, etc. required to form each coil 104, as compared to conventional coils. In turn, manufactory costs and losses may be reduced, and efficiency of an axial-flux machine including such coils may be increased.

Additionally, the coils 104 can be wound directly on the stator 100 and/or another suitable stator from an exterior portion (e.g., an outer periphery, a top surface, a bottom surface, etc.) of the stator. For example, each coil 104 may be wound on the stator 100 and/or another suitable stator without substantially utilizing an interior portion (e.g., an inner periphery) of the stator.

Each coil 104 of FIGS. 1-3 includes a substantially similar shape. For example, each coil 104 includes four coil segments arranged to form two “V” shaped coil portions 116, 118, as explained above. In particular, the coil portion 116 includes coil segments 132, 134 arranged to form a “V” shape, and the coil portion 118 includes coil segments 136, 138 arranged to form a “V” shape. This “V” shaped configuration creates an opening between the coil segments 132, 134, and an opening between the coil segments 136, 138.

For example, the coil segment 132 extends from the vertex 120 to the end 124 of the coil portion 116, and the coil segment 134 extends from the vertex 120 to the end 126 of the coil portion 116. Similarly, the coil segment 136 extends from the vertex 122 to the end 128 of the coil portion 118, and the coil segment 138 extends from the vertex 122 to the end 130 of the coil portion 118. The end 124 is coupled to the end 128 and the end 126 is coupled to the end 130. This configuration may be considered a tetrahedron like shape.

In the particular example of FIGS. 1-3, the coil portion 116 and the coil portion 118 are coupled together only at their ends 124, 126. This configuration causes creates openings between the “V” shaped coil portions 116, 118, as shown in FIG. 3. For example, each coil 104 defines an opening between the coil segment 132 of the coil portion 116 and the coil segment 136 of the coil portion 118, and an opening between the coil segment 134 of the coil portion 116 and the coil segment 138 of the coil portion 118.

The “V” shaped coil portion 116 and the “V” shaped coil portion 118 each extend in a plane. As shown in FIGS. 1 and 3, the plane of the coil portion 116 intersects the plane of the coil portion 118 adjacent to the ends of the coil portions 116, 118. For example, and as shown in FIG. 1, each coil portion 116, 118 extends inwardly from one side of the stator 100 adjacent the stator's inner periphery 106 towards each other and intersects adjacent the stator's outer periphery 108. This causes the end turns formed by the ends 124, 126 to become smaller as compared to conventional end turns, as explained above. Alternatively, the planes may extend substantially parallel (as further explained below), intersect at another location, etc.

As shown, the vertex 120 of the “V” shaped coil portion 116 is adjacent the inner periphery 106 of the stator 100 and the ends 124, 126 of the “V” shaped coil portion 116 are adjacent the outer periphery 108 of the stator 100. Likewise, the vertex 122 of the “V” shaped coil portion 118 is adjacent the inner periphery 106 of the stator 100 and the ends 128, 130 of the “V” shaped coil portion 118 are adjacent the outer periphery 108 of the stator 100. In other embodiments, the vertexes may be adjacent the outer periphery 108 and the ends may be adjacent the inner periphery 106.

As shown in FIG. 1, a cross section of the stator 100 includes a substantially triangular shape. For example, a length (e.g., a height) of the inner periphery 106 is larger than a length of the outer periphery 108. In the particular embodiment of FIG. 1, the distance between opposing surfaces 140, 142 (e.g., sometimes referred to as a top surface 140 and a bottom surface 142) adjacent the inner periphery 106 is larger than the distance between the opposing surfaces 140, 142 adjacent the outer periphery 108. Additionally, the distance between the inner periphery 106 and the outer periphery 108 along the top surface 140 of the stator core 102 can be substantially the same as the distance between the inner periphery 106 and the outer periphery 108 along the bottom surface 142 of the stator core 102, as shown in FIG. 1. As such, the stator core 102 of FIG. 1 forms an isosceles triangular shape.

Alternatively, the inner periphery length (e.g., height) may be smaller than the outer periphery length, the inner periphery and the outer periphery may have substantially the same length, the top surface distance may be different than the bottom surface, the stator core may form another suitable triangular shape (e.g., right triangle, etc.), etc.

The teeth 112 are positioned on opposing sides of the stator yoke 110. For example, and as shown in FIG. 1, the teeth 112a extend from the stator yoke 110 to create the top surface 140 of the stator core 102 and the teeth 112b extend from the stator yoke 110 to create the bottom surface 142 of the stator core 102.

In the particular example of FIG. 1, the teeth 112a and the teeth 112b are substantially aligned. As such, one set of aligned teeth 112a, 112b on opposing sides of the stator yoke 110 can define aligned slots 114a, b for accommodating one coil 104. In other embodiments, the teeth 112a, 112b may be offset without departing from the scope of the disclosure.

Additionally, as shown best in FIG. 2, a cross section of the teeth 112a includes a substantially triangular shape. For example, a length (e.g., a radial length, etc.) of each tooth 112a adjacent the stator's inner periphery 106 is smaller than a length (e.g., a radial length, etc.) of each tooth 112a adjacent the stator's outer periphery 108. Although not shown, the teeth 112b include the same configuration as the teeth 112a. This allows each coil 104 to form a “V” shape when looking from the axial direction (e.g., the X-axis as shown in FIGS. 1-5).

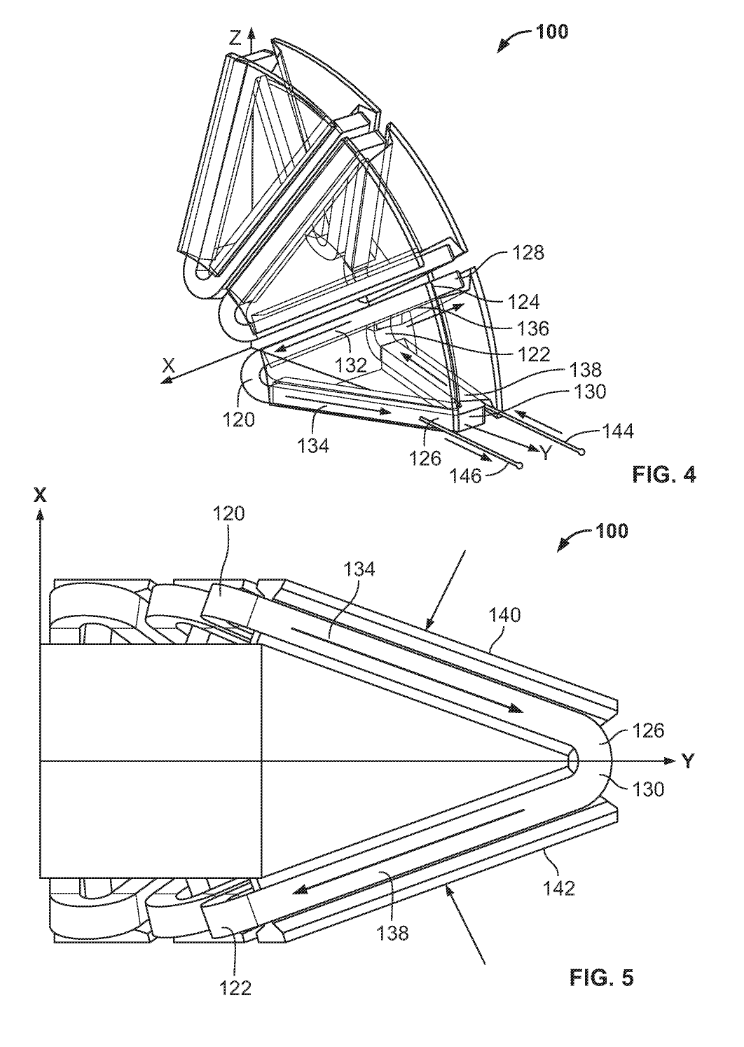

FIGS. 4 and 5 illustrate the stator 100 of FIGS. 1 and 2 with current flowing in one coil 104 and a corresponding magnetic flux. For example, and as shown in FIGS. 4 and 5, current flows through the coil segments 132, 134, 136, 138 to create a magnetic flux. In the particular example of FIGS. 4 and 5, current flows from the end 130 to the vertex 122, from the vertex 122 to the ends 128, 124, from the ends 128, 124 to the vertex 120, and from the vertex 120 to the end 126. This creates inward directed magnetic flux on opposing sides (e.g., the top surface 140 and the bottom surface 142) of the stator core 102, as shown in FIG. 5.

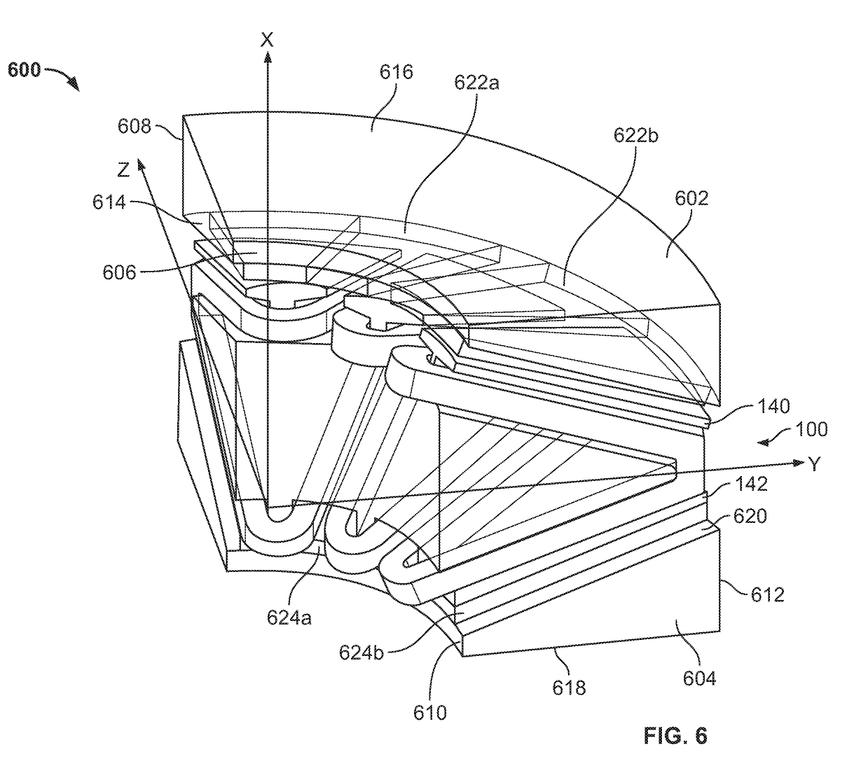

The stator 100 of FIGS. 1 and 2 can be a stator of an axial flux dynamoelectric machine such as an axial flux motor, an axial flux generator, etc. For example, FIG. 6 illustrates a portion of an axial flux motor 600 including the stator 100 of FIGS. 1 and 2 and two rotors 602, 604 adjacent opposing sides of the stator 100. In particular, the rotor 602 is adjacent the top surface 140 of the stator 100 and the rotor 604 is adjacent the bottom surface 142 of the stator 100. This configuration is sometimes referred to a double sided motor.

The rotors 602, 604 of FIG. 6 are preferably rotated synchronously and coupled to one shaft (not shown). For example, the rotors 602, 604 can be rotated at the same speed and in the same direct. In other embodiments, the rotors 602, 604 may be rotated synchronously and coupled to different shafts.

In other embodiments, the motor 600 and/or other dynamoelectric machines disclosed herein may include another suitable configuration. For example, the motor 600 and/or the other dynamoelectric machines may include two stators (e.g., one or both of which may be the stator 100, etc.) and one rotor positioned between the stators. In other embodiments, the machines may include three rotors and two stators.

As shown in FIG. 6, a cross section of each rotor 602, 604 includes a substantially triangular shape. Specifically, each rotor 602, 604 forms a right triangular shape. For example, the rotor 602 is defined by an inner periphery 606, an outer periphery 608, and opposing surfaces 614, 616 extending between the inner periphery 606 and the outer periphery 608. Similarly, the rotor 604 is defined by an inner periphery 610, an outer periphery 612, and opposing surfaces 618, 620 extending between the inner periphery 610 and the outer periphery 612. In the particular example of FIG. 6, the outer periphery 608 and the surface 614 of the rotor 602 form a right angle, and the outer periphery 612 and the surface 618 of the rotor 604 form a right angle.

Additionally, and as shown in FIG. 6, a length (e.g., a height) of each inner periphery 606, 610 is smaller than a length of its corresponding outer periphery 608, 612. For example, the distance between the opposing surfaces 614, 616 adjacent the inner periphery 606 of the rotor 602 is smaller than the distance between the opposing surfaces 614, 616 adjacent the outer periphery 608 of the rotor 602. Likewise, the distance between opposing surfaces 618, 620 adjacent the inner periphery 610 of the rotor 604 is smaller than the distance between the opposing surfaces 618, 620 adjacent the outer periphery 612 of the rotor 604.

Further, the distance between the inner periphery 606 and the outer periphery 608 along the surface 616 of the rotor 602 is longer than the distance between the inner periphery 606 and the outer periphery 608 along the surface 614 of the rotor 602. Similarly, the distance between the inner periphery 610 and the outer periphery 612 along the surface 620 of the rotor 604 is longer than the distance between the inner periphery 610 and the outer periphery 612 along the surface 618 of the rotor 604. These distances (e.g., between opposing surfaces adjacent a particular periphery, between opposing peripheries along a particular periphery, etc.) at least partially create the right angles as explained above.

In other embodiments, the inner periphery length (e.g., height) may be larger than, substantially the same as, etc. the outer periphery length, the top surface distance may be substantially the same as the bottom surface distance, the stator core may form another suitable triangular shape (e.g., an isosceles triangle, etc.), etc.

As shown in FIG. 6, a cross section of the motor 600 includes a substantially rectangular shape. For example, each rotor 602, 604 having a substantially right triangular shape and the stator 100 having a substantially isosceles triangular shape (as explained above) are complementary to each other. These three triangular shaped components form a substantially rectangular shape motor.

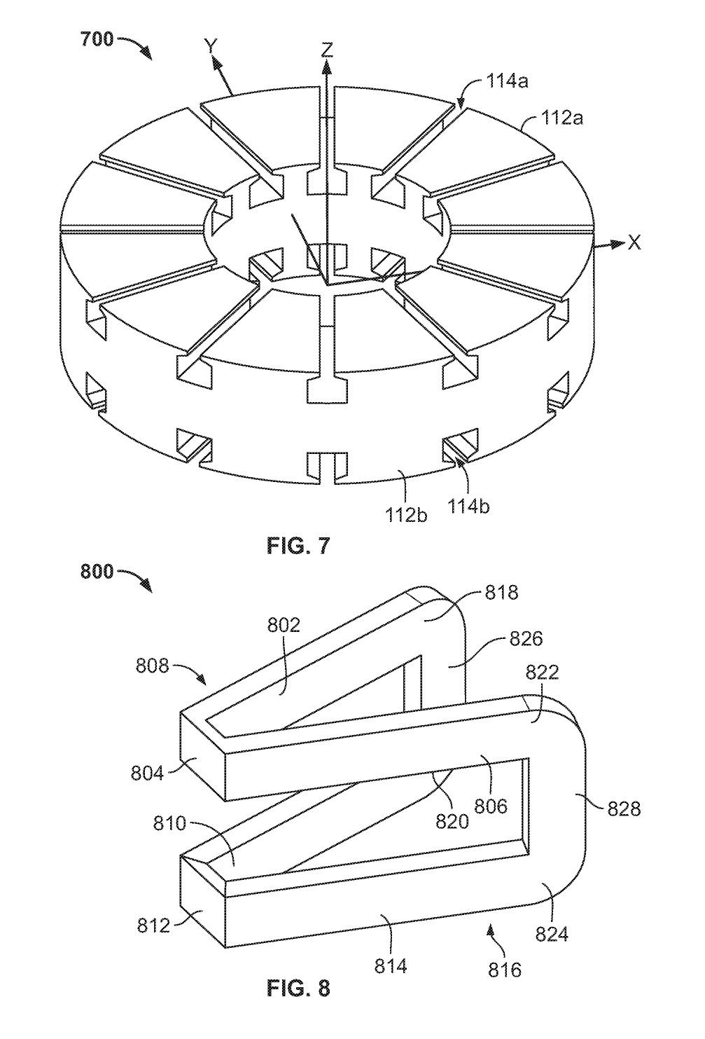

In some embodiments, the stator and/or the coils may be configured (e.g., shaped, etc.) differently than as shown in FIGS. 1-6. For example, FIG. 7 illustrates a stator 700 substantially similar to the stator 100 of FIGS. 1 and 2, but including a different cross sectional shape. In the particular embodiment of FIG. 7, the stator 700 includes a rectangular cross section.

FIG. 8 illustrates a coil 800 employable in the stator 700. For example, teeth (on opposing sides of the stator 700) define slots that may accommodate the coil 800 and/or other suitable coil configurations. In some examples, the coil 800 can be wound directly on the stator 700 and/or another suitable stator from an exterior portion of the stator, as explained above.

The coil 800 of FIG. 8 is substantially similar as the coils 104 of FIGS. 1-6, but includes a different shape. For example, the coil 800 includes coil segments 802, 804, 806 arranged to form a “V” shaped coil portion 808, and coil segments 810, 812, 814 arranged to form another “V” shaped coil portion 816. In particular, the coil segments 802, 806 extend between a vertex (e.g., the coil segment 804) and ends 818, 822, respectively. Similarly, the coil segments 810, 814 extend between a vertex (e.g., the coil segment 812) and ends 820, 824, respectively. As such, the coil 800 forms a “V” shape when looking from an axial direction (e.g., the Z-axis as shown in FIG. 7), when positioned on the stator 700 of FIG. 7.

As shown in FIG. 8, the end 818 of the coil portion 808 is coupled to the end 820 of the coil portion 816 via a coil segment 826. Likewise, the end 822 of the coil portion 808 is coupled to the end 824 of the coil portion 816 via a coil segment 828. The coil portions 808, 816 are coupled together only via the segments 826, 828.

In the particular example of FIG. 8, the coil portions 808, 816 extend in substantially parallel planes. For example, the coil segments 826, 828 may be substantially perpendicular to the coil segments 802, 806, 810, 814, as shown in FIG. 8. Additionally, the length of the coil segments 826, 828 (e.g., the distance between the ends 818, 820 and between 822, 824) and the distance between the coil segments 804, 812 may be chosen such that the coil portions 808, 816 extend in parallel planes. In other embodiments, the planes may not extend parallel to each other if desired.

In the particular example of FIG. 8, the coil 800 includes four end turns, as explained above. For example, one end turn is formed by the coil segment 804 (e.g., one vertex), another end turn is formed by the coil segment 812 (e.g., another vertex), and two other end turns are formed by the coil segments 826, 828.

Similar to the coils 104 of FIGS. 1-6, the coil 800 of FIG. 8 may be formed to create various openings between the coil segments. For example, the coil 800 defines an opening between the coil portions 808, 816. In particular, openings are created between the coil segments 802, 804, 806 of the coil portion 808 and the coil segments 810, 812, 814 of the coil portion 816, respectively. Additionally, the coil 800 defines an opening between coil segments of each of the coil portions 808, 816. For example, openings are created between the coil segments 802, 804, 806 and between the coil segments 810, 812, 814.

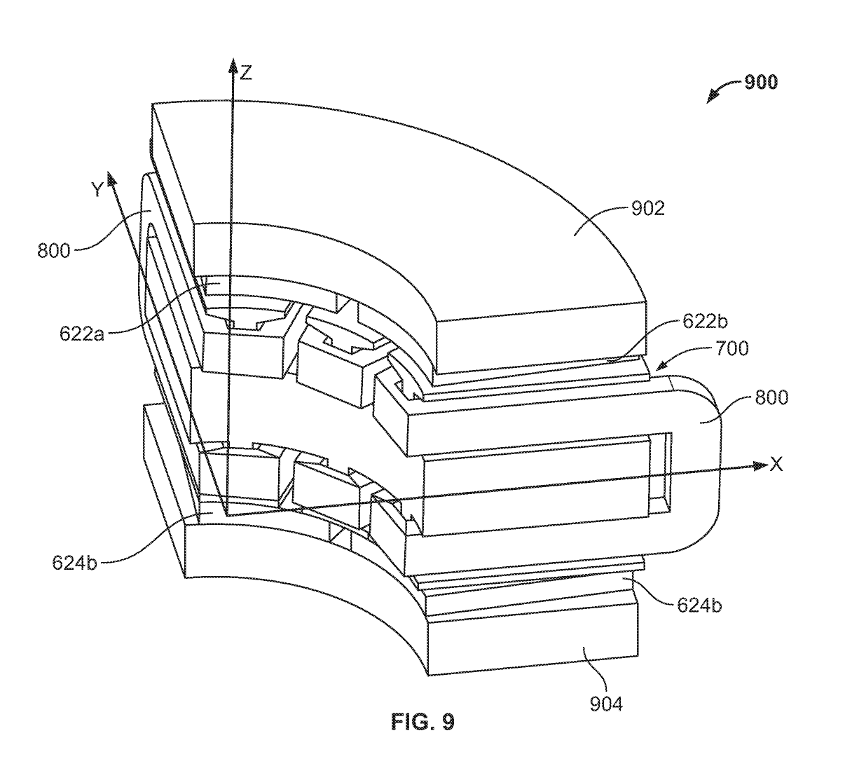

FIG. 9 illustrates a portion of a dynamoelectric machine such as an axial flux motor 900 including the stator 700 of FIG. 7, coils 800 of FIG. 8, and two rotors 902, 904 adjacent opposing sides of the stator 700. The rotors 902, 904 are substantially similar to the rotors 602, 604 of FIG. 6, but include a different cross sectional shape. For example, and as shown in FIG. 9, the rotors 902, 904 include a substantially rectangular cross sectional shape.

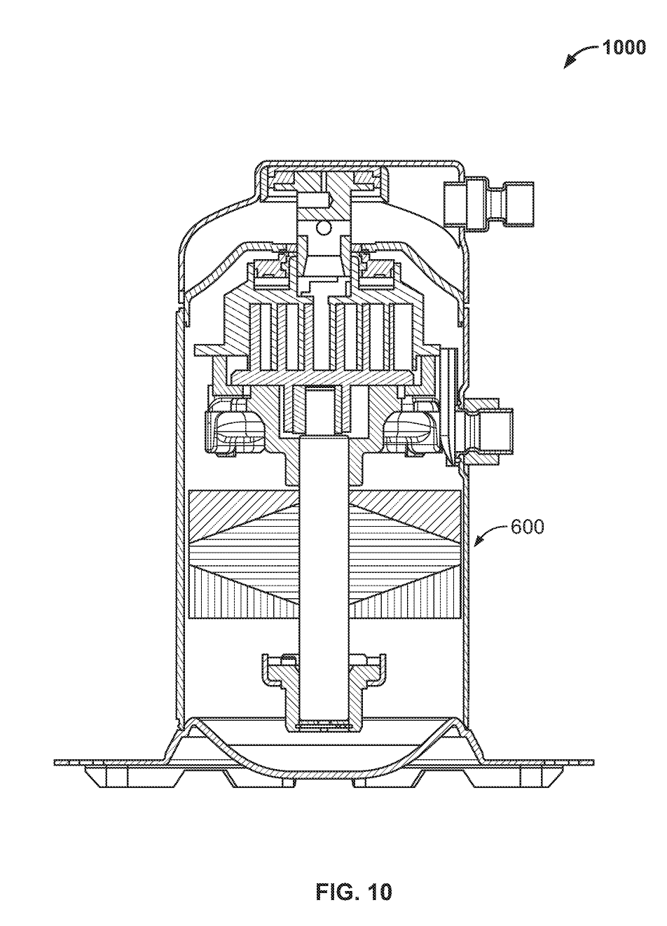

The dynamoelectric machines, the stators, etc. disclosed herein may be used in various applications. For example, any one of the stators disclosed herein may be employed in a motor, a generator, etc. In some embodiments, a motor including one or more of the stators may be used in a compressor. For example, FIG. 10 illustrates a compressor 1000 including the axial flux motor 600 of FIG. 6. The coils and magnets (further explained below) of the motor 600 are not shown for clarity. Alternatively, the compressor 1000 may include the axial flux motor 900 and/or another suitable motor without departing from the scope of the disclosure.

In some embodiments, the compressor 1000 may be a variable speed compressor. In such examples, the variable speed compressor may be a scroll compressor. In other embodiments, the compressor 1000 may be another suitable compressor.

Additionally, the dynamoelectric machines disclosed herein may include magnets such as permanent magnets. For example, and as shown in FIGS. 6 and 9, the axial flux motors 600, 900 each includes magnets 622 and magnets 624 on opposing sides of the stator 100, 700, respectively. In the particular example of FIG. 6, the motor 600 includes magnets 622 between the rotor 602 and the stator 100 and magnets 624 between the rotor 604 and the stator 100. In particular, the magnets 622 are positioned between a bottom surface of the rotor 602 and the top surface 140 of the stator 100, and the magnets 624 are positioned between a top surface of the rotor 604 and the bottom surface 142 of the stator 100. In such examples, the magnets 622, 624 are mounted to a surface of the rotors 602, 604 via, for example, an adhesive and/or another suitable fastener. The magnets 622, 624 of the motor 900 of FIG. 9 are similarly positioned between its stator 700 and rotors 902, 904.

In other embodiments, the rotors 602, 604, 902, 904 of FIGS. 6 and 9 may include one or more magnet slots for receiving one or more magnets to replace and/or to supplement the magnets 622, 624. In such embodiments, the magnets are inserted into the magnet slots of the rotors 602, 604.

The magnets 622, 624 may be arranged in a particular configuration. For example, the magnets 622 include magnets 622a, 622b of alternating polarity. Similarly, the magnets 624 include magnets 624a, 624b of alternating polarity. As shown in FIGS. 6 and 9, the magnet 622a is aligned with the magnet 624a and the magnet 622b is aligned with the magnet 624b.

The magnets 622a, 622b, 624a, 624b may be arranged in a particular magnet configuration. For example, the magnets 622, 624 of FIGS. 6 and 9 are arranged in a north-north (N-N) magnet configuration. In such examples, the magnets 622a, 624a have the same polarity (e.g., a south polarity) and the magnets 622b, 624b have the same polarity (e.g., a north polarity). In this case, magnetic flux would flow from one magnet (e.g., the magnet 624b having a north polarity) into the stator and to an adjacent magnet (e.g., the magnet 624a having a south polarity) on the same side of the stator.

In other examples, the magnets 622, 624 may be arranged in a north-south (N-S) magnet configuration. In such examples, the magnets 622a, 624a have the opposite polarity and the magnets 622b, 624b have the opposite polarity. As such, the magnetic flux would flow from one magnet (e.g., the magnet 624b having a north polarity) into the stator and to another magnet (e.g., the magnet 622b having a south polarity) on the opposing side of the stator.

As explained above, FIGS. 6 and 9 illustrate one fourth of the motor 600, 900. Thus, although FIGS. 6 and 9 illustrate two magnets 622 and two magnets 624, the motor 600, 900 each include eight magnets 622, 624 of alternating polarity. As such, the motors 600, 900 may be considered to have eight poles. Alternatively, the motor 600, 900 and/or another suitable motor may include more or less magnets. In that event, the motor will have more or less than eight poles. For example, the motor 600 (and/or other motors described herein) may have four poles, twelve poles, or any other desired even number of poles.

Additionally, and as shown best in FIG. 6, the magnets 622, 624 include two trapezoid shaped magnet portions. In other embodiments, the magnets 622, 624 may be another suitable shape such as triangular, etc., may include more or less magnet portions, etc.

Further, the portion of the stator 100 shown in FIGS. 1 and 2 includes three teeth 112a (and three corresponding slots 114a) to create the top surface 140, and three teeth 112b (and three corresponding slots 114b) to create the bottom surface 142. As such, because FIGS. 1 and 2 illustrate one fourth of the stator 100, the stator 100 includes twelve teeth 112a and twelve slots 114a adjacent the top surface 140, and twelve teeth 112b and twelve slots 114b adjacent the bottom surface 142. Similarly, the stator 700 of FIG. 7 includes twelve teeth 112a and twelve slots 114a, and twelve teeth 112b and twelve slots 114b on opposing sides of the stator 700. Alternatively, the stators 100, 700 and/or other stators disclosed herein may include more or less teeth and slots without departing from the scope of the disclosure.

The coils disclosed herein may be formed of one or more wires, plates and/or another suitable material. For example, the coils 104 of FIGS. 1-6 and the coils 800 of FIGS. 8 and 9 include plates. As such, the one or more windings formed from the coils may be considered plate windings.

The coils may be made of one or more electrical conductive materials. For example, the coils may be made of copper, aluminum, another suitable electrical conductive material and/or an alloy thereof.

Additionally, the coils may be formed in various different manners. In some embodiments, the coils may be pre-formed. For example, and as shown in FIGS. 3A and 3B, the coil 104 is pre-formed into a diamond like shape, and then folded at the vertexes 120, 122 to form the “V” shaped coil. The coil 104 can then be placed on the stator 100, as shown in FIGS. 1 and 2. In other embodiments, one or more wires, plates and/or another suitable material may be wound directly on the stator 100 (e.g., the stator core 102) to form the “V” shaped coil.

Further, the coils disclosed herein can include coil leads for receiving current from and/or outputting current to a power source. For example, as shown in FIG. 4, the coils 104 may include a coil lead 144 for receiving current and a coil lead 146 for outputting current. Although not shown, each coil 104 may include its own respective coil leads. In other embodiments, one or more coils may share similar coil leads to, for example, form a winding.

Although the coils are each described as having vertexes and ends, it should be apparent to those skilled in the art that the coils may include substantially rounded corners. For example, and as shown in FIGS. 1-5, the coils 104 each have substantially rounded corners. This may be possible due to, for example, the softness, the flexibility, etc. of the electrical conductive materials used to form the coils.

The stators disclosed herein may be formed in any suitable manner using any suitable materials. For example, the stators may employ a segmented or non-segmented construction, and may or may not include multiple laminations stacked together. The laminations may be formed of steel, cast iron, aluminum, or other suitable materials. In the particular examples of FIGS. 1-10, the stator 100 (e.g., the stator core 102) and the stator 700 are non-segmented stators. In other embodiments, the stator 100 and/or the stator 700 may be segmented.

The stators and/or the rotors disclosed herein may be made of one or more ferromagnetic materials. Preferably, the stators and/or the rotors are made of iron and/or an alloy thereof. In other embodiments, the stators and/or the rotors can be made of other suitable ferromagnetic materials such as nickel, cobalt, etc. and/or an alloy thereof.

The machines disclosed herein may be single-phase machines driven by single phase AC power sources or polyphase machines (e.g., three-phase motors, etc.) driven by polyphase AC power sources (e.g., three-phase AC power sources). Thus, a machine (e.g., a motor, etc.) driven by a single phase AC power source is a single-phase motor, even if that machine includes multiple windings such as a main winding, an auxiliary/start winding, one or more tapped windings for varying speed of the motor, etc. In the particular examples of FIGS. 6 and 9, the axial-flux dynamoelectric motors 600 and 900 are three phase motors. In other embodiments, one or both motors 600 and 900 may be configured as another polyphase motor and/or a single phase motor without departing from the scope of the disclosure.

As explained above, by employing the stators and/or the coils disclosed herein, the size of coil end turns may be reduced as compared to end turns of conventional stators while maintaining a similar magnetic flux flow direction (e.g., a similar magnetic flux field) as conventional stators. This reduction in size may reduce costs for manufacturing the stators, reduce resistance in the stators, etc. as less material such as copper is required, compared conventional stators. In turn, losses may be reduced, and efficiency and power density of axial-flux machines including such stators and/or coils may be increased.

For example, testing has shown that when a current of 4.6 amps is provided to winding(s) of the stators disclosed herein (e.g., the stator 100 of FIG. 1) and a conventional stator, the resistance in the subject stators is about 0.204 ohms while a conventional stator is about 0.223 ohms. This results in a loss of about 12.9 watts for the subject stators and about 14.1 watts for the conventional stator. As a result, the subject stators obtain an efficiency of about 93.10% and the conventional stator obtains an efficiency of about 92.89%.

Additionally, machines employing one of the stators may have a larger air gap surface area along a stator surface than conventional designs. This larger surface area allows users to employ larger magnet(s) with the stators. For example, and as shown in FIG. 1, the top surface 140 and the bottom surface 142 of the stator 100 may each be sloped at a particular angle (e.g., about twenty degrees, etc.). In such examples, the motor 600 of FIG. 6, which includes the stator 100, has an air gap surface area along each stator surface that is 1.064 (i.e., 1/cos (20°)) times larger than an air gap surface area (i.e., 1/cos)(0°)=1) of a conventional stator having no slope (e.g., a zero degree slope). This larger air gap surface area increases an air gap volume compared to conventional designs, assuming an air gap (e.g., a distance) between the stator and the rotor is substantially the same for the motor 600 and the conventional design. As such, larger magnet(s) can be used with the stator 100 compared to conventional designs.

Further, the reduced resistance and increased air gap surface area may be realized when employing existing stators. For example, the stator 700 FIGS. 7 and 9 may be an existing stator and the coils 800 of FIGS. 8 and 9 may be designed to include a V-shaped configuration as disclosed herein to realize the benefits referenced above. As such, manufacturing costs associated with designing and making a stator may be reduced if an existing stator is employed.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An axial-flux dynamoelectric machine comprising:
at least one rotor, and
at least one stator adjacent the at least one rotor in an axial direction, the at least one stator defined by an inner periphery and an outer periphery, the at least one stator including a stator yoke, a plurality of teeth extending from the stator yoke, and a plurality of coils, at least one of the plurality of coils configured to form a winding, the plurality of teeth spaced apart from one another to define a plurality of slots for receiving the plurality of coils, each coil of the plurality of coils including a first set of segments and a second set of segments each extending between the inner periphery and the outer periphery of the stator, the first set of segments arranged to form a first coil portion having a “V” shape relative to a cross-section of the stator, the second set of segments arranged to form a second coil portion having a “V” shape relative to a cross-section of the stator, the first coil portion and the second coil portion each having a vertex and two ends, and the ends of the first coil portion coupled to the ends of the second coil portion.

2. The machine of claim 1 wherein the first coil portion and the second coil portion are coupled together only at their ends.

3. The machine of claim 1 wherein the first coil portion extends in a plane and wherein the second coil portion extends in a plane substantially parallel to the plane of the first coil portion.

4. The machine of claim 1 wherein the first coil portion extends in a plane, wherein the second coil portion extends in a plane, and wherein the plane of the first coil portion intersects the plane of the second coil portion adjacent to the ends of the first coil portion and the ends of the second coil portion.

5. The machine of claim 1 wherein the vertex of the first coil portion and the vertex of the second coil portion are adjacent the inner periphery of the stator, and wherein the ends of the first coil portion and the ends of the second coil portion are adjacent the outer periphery of the stator.

6. The machine of claim 1 wherein the at least one rotor is defined by an inner periphery, an outer periphery, and opposing surfaces extending between the inner periphery of the rotor and the outer periphery of the rotor, and wherein a distance between the opposing surfaces of the rotor adjacent its inner periphery is smaller than a distance between the opposing surfaces of the rotor adjacent its outer periphery.

7. The machine of claim 6 wherein the at least one stator is defined by the inner periphery, the outer periphery and opposing surfaces extending between the inner periphery and the outer periphery, and wherein a distance between the opposing surfaces of the stator adjacent its inner periphery is larger than a distance between the opposing surfaces of the stator adjacent its outer periphery.

8-9. (canceled)

10. The machine of claim 1 wherein the at least one rotor includes two rotors adjacent opposing sides of the at least one stator.

11. The machine of claim 10 further comprising a first plurality of magnets between one of the two rotors and the at least one stator and a second plurality of magnets between another one of the two rotors and the at least one stator.

12. The machine of claim 11 wherein the first plurality of magnets and the second plurality of magnets are arranged to form a north-north magnet configuration.

13. The machine of claim 1 wherein the machine includes an axial flux motor.

14. A compressor including the axial flux motor of claim 13.

15. A stator assembly for an axial-flux dynamoelectric machine, the stator assembly comprising:
a stator core defined by an inner periphery and an outer periphery, the stator core including a stator yoke and a plurality of teeth extending from the stator yoke, the plurality of teeth spaced apart from one another to define a plurality of slots, and
a plurality of coils positioned in the plurality of slots, at least one of the coils configured to form a winding, each coil of the plurality of coils including a first set of segments and a second set of segments each extending between the inner periphery and the outer periphery of the stator core, the first set of segments arranged to form a first coil portion having a “V” shape relative to a cross-section of the stator assembly, the second set of segments arranged to form a second coil portion having a “V” shape relative to a cross-section of the stator assembly, the first coil portion and the second coil portion each having a vertex and two ends, and the ends of the first coil portion coupled to the ends of the second coil portion.

16. The stator assembly of claim 15 wherein the first coil portion and the second coil portion are coupled together only at their ends.

17. The stator assembly of claim 16 wherein the first coil portion extends in a plane and wherein the second coil portion extends in a plane substantially parallel to the plane of the first coil portion.

18. The stator assembly of claim 16 wherein the first coil portion extends in a plane, wherein the second coil portion extends in a plane, and wherein the plane of the first coil portion intersects the plane of the second coil portion adjacent to the ends of the first coil portion and the ends of the second coil portion.

19. The stator assembly of claim 15 wherein the vertex of the first coil portion and the vertex of the second coil portion are adjacent the inner periphery of the stator core, and wherein the ends of the first coil portion and the ends of the second coil portion are adjacent the outer periphery of the stator core.

20. The stator assembly of claim 15 wherein the stator core is defined by the inner periphery, the outer periphery and opposing surfaces extending between the inner periphery and the outer periphery, and wherein a distance between the opposing surfaces adjacent the inner periphery is larger than a distance between the opposing surfaces adjacent the outer periphery.

21. The stator assembly of claim 15 wherein the at least one stator core is a non-segmented stator core.

22. A compressor including at least one rotor and the stator assembly of claim 15 adjacent the at least one rotor.
